(19) United States
(12) Patent Application Publication
(10) Pub. No.: US 2026/0333032 A1
(43) Pub. Date: Oct. 22, 2026

(54) Methods and apparatus for key establishment and feedback encryption in multi-access point wireless communications

(71) Applicant: MEDIATEK INC., Hsinchu City (TW)

(72) Inventors: Tao-Chun Lee, Hsinchu City (TW); Li-Hsiang Sun, San Jose, CA (US); Gabor Bajko, San Jose, CA (US)

(73) Assignee: MEDIATEK INC., Hsinchu City (TW)

(21) Appl. No.: 19/640,436

(22) Filed: Apr. 7, 2026

Related U.S. Application Data
(60) Provisional application No. 63/790,051, filed on Apr. 17, 2025.

(51) Int. Cl. H04W 12/0431; H04B 7/06; H04W 12/041; H04W 12/06

(52) U.S. Cl. CPC H04W 12/0431; H04B 7/0617; H04W 12/041; H04W 12/06

(57) ABSTRACT

Methods, network devices, and wireless devices for protecting feedback and coordination information in multi-access point coordination wireless communications are disclosed. Two network devices establish a shared cryptographic key through a key agreement procedure involving public key exchange and shared secret derivation. One network device distributes the shared cryptographic key to an associated wireless device. The wireless device encrypts feedback information, including channel state information, using the shared cryptographic key, enabling both network devices to decrypt the encrypted feedback information. The network devices encrypt coordination information exchanged between them using the shared cryptographic key.

### CROSS REFERENCE TO RELATED APPLICATIONS

This application claims the benefit of U.S. Provisional Application No. 63/790,051, filed on Apr. 17th, 2025. The content of the application is incorporated herein by reference.

### BACKGROUND

Wireless local area networks (WLANs) have evolved through multiple generations of IEEE 802.11 standards to support increasing data throughput and device density. Among various techniques adopted in modern WLAN systems, multi-user multiple-input multiple-output (MU-MIMO) enables an access point (AP) to serve multiple stations (STAs) concurrently based on channel state information (CSI) fed back from the STAs during a channel sounding procedure.

In a wireless local area network operating in accordance with IEEE 802.11 standards, the channel sounding procedure involves the access point (AP) operating as a beamformer and the station operating as a beamformee. The AP initiates the channel sounding procedure by transmitting a null data packet announcement (NDPA) frame followed by a null data packet (NDP). The NDPA frame identifies one or more stations from which beamforming feedback is requested. Upon receiving the NDP, each identified station estimates the channel frequency response from the known training fields carried in the NDP. The station then performs a matrix decomposition, such as a singular value decomposition (SVD), on the estimated channel matrix and extracts a beamforming feedback matrix from the decomposition result. The beamforming feedback matrix is compressed into a set of beamforming feedback angles through a compression procedure defined in the standard. The beamforming feedback angles are quantized to reduce transmission overhead and are transmitted back to the AP in a compressed beamforming report. The AP may solicit the compressed beamforming report by transmitting a beamforming report poll (BFRP) trigger frame, and the station transmits the report in a trigger-based physical layer protocol data unit (TB PPDU). In some configurations, the compressed beamforming report is carried in an action frame. Under the IEEE 802.11 standard as of the time of this disclosure, certain action frames carrying beamforming feedback may be classified as non-robust action frames, which are transmitted without media access control (MAC) layer encryption even when a security association exists between the AP and the station.

The channel sounding procedure may be vulnerable to attack. In some approaches, the CSI reports transmitted from STAs to APs may not be protected by encryption. Without such protection, an attacker may capture or falsify the feedback information and reduce the performance of downlink multi-user transmissions.

Recent amendments to the IEEE 802.11 standard have introduced multi-AP coordination (M-APC) capabilities, in which multiple APs coordinate their transmissions to manage interference in overlapping coverage areas. In the M-APC framework, one access point operates as a coordinating AP (also referred to herein as a sharing AP) that acquires a transmission opportunity and initiates the coordination, and another access point operates as a coordinated AP (also referred to herein as a shared AP) that participates in the coordinated operation. The M-APC framework operates through multiple phases. In a first phase, the sharing AP and the shared AP discover each other and exchange capability information through management frames, such as MAPC Discovery Request frames and MAPC Discovery Response frames. In a second phase, the sharing AP and the shared AP negotiate coordination parameters by exchanging individually addressed management frames to establish coordination agreements for specific multi-AP coordination schemes including coordinated beamforming (Co-BF) and coordinated spatial reuse (Co-SR). In a third phase, the sharing AP and the shared AP perform coordinated transmissions using control frames in accordance with the negotiated coordination parameters. In M-APC scenarios, a shared AP may also use the CSI reported by a STA associated with the sharing AP for coordinated beamforming. However, in some approaches, if the STA encrypts its feedback information using a pairwise key established between the STA and the sharing AP, the shared AP may not be able to decrypt the feedback because the shared AP may not hold the pairwise key.

In addition, APs in an M-APC architecture may exchange coordination information during a negotiation procedure. In some approaches, such inter-AP communications may not be protected by encryption. Without such protection, the coordination information exchanged between APs may be exposed to interception or modification.

### SUMMARY

An embodiment of the present disclosure provides a method for wireless communications. A first network device exchanges security information with a second network device for establishing a shared cryptographic key. The first network device derives the shared cryptographic key based on the exchanged security information. The first network device encrypts coordination information using the shared cryptographic key. The coordination information is associated with a coordinated wireless operation involving the first network device and the second network device. The first network device transmits the encrypted coordination information to the second network device.

Another embodiment of the present disclosure provides a method for wireless communications. A first wireless device receives coordination information from a first network device. The coordination information indicates that the first network device is operating in a coordinated mode with a second network device. The first wireless device receives a shared cryptographic key from the first network device. The shared cryptographic key has been previously established between the first network device and the second network device. The first wireless device encrypts feedback information using the shared cryptographic key. The feedback information comprises channel state information associated with a communication channel between the first wireless device and the first network device. The first wireless device transmits the encrypted feedback information. The encrypted feedback information is decodable by both the first network device and the second network device using the shared cryptographic key.

Another embodiment of the present disclosure provides a method for wireless communications. A first network device establishes a shared cryptographic key with a second network device. The shared cryptographic key is for protecting communications associated with a coordinated operation between the first network device and the second network device. The first network device transmits the shared cryptographic key to a first wireless device. The first network device receives encrypted feedback information from the first wireless device. The encrypted feedback information is generated by the first wireless device by encrypting feedback information using the shared cryptographic key. The feedback information comprises channel state information associated with a communication channel between the first wireless device and the first network device. The first network device decrypts the encrypted feedback information using the shared cryptographic key.

Another embodiment of the present disclosure provides a network device. The network device comprises a transceiver, one or more processors coupled to the transceiver, and a memory coupled to the one or more processors. The memory stores instructions that, when executed by the one or more processors, cause the network device to perform operations. The network device establishes a shared cryptographic key with a second network device for protecting communications associated with a coordinated operation. The network device transmits, via the transceiver to a first wireless device, the shared cryptographic key. The network device receives, via the transceiver from the first wireless device, encrypted feedback information. The encrypted feedback information is generated by the first wireless device by encrypting feedback information using the shared cryptographic key. The feedback information comprises channel state information associated with a communication channel between the first wireless device and the network device. The network device decrypts the encrypted feedback information using the shared cryptographic key.

Another embodiment of the present disclosure provides a wireless device. The wireless device comprises a transceiver configured to communicate with a first network device, one or more processors coupled to the transceiver, and a memory coupled to the one or more processors. The memory stores instructions that, when executed by the one or more processors, cause the wireless device to perform operations. The wireless device receives, via the transceiver, coordination information from the first network device. The coordination information indicates that the first network device is operating in a coordinated mode with a second network device. The wireless device receives, via the transceiver from the first network device, a shared cryptographic key established between the first network device and the second network device. The wireless device encrypts feedback information using the shared cryptographic key. The feedback information comprises channel state information associated with a communication channel between the wireless device and the first network device. The wireless device causes the transceiver to transmit the encrypted feedback information.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a schematic diagram illustrating a wireless communication system including a first network device, a second network device, and wireless devices operating in overlapping basic service sets, according to an embodiment of the present disclosure.

FIG. 2 is a block diagram illustrating internal components of the first network device, the second network device, and the wireless devices of FIG. 1, according to an embodiment of the present disclosure.

FIG. 3 is a message sequence diagram illustrating a key establishment procedure between the first network device and the second network device, according to an embodiment of the present disclosure.

FIG. 4 is a message sequence diagram illustrating a key distribution and encrypted feedback procedure among a wireless device, the first network device, and the second network device, according to an embodiment of the present disclosure.

FIG. 5 is a message sequence diagram illustrating an encrypted coordination procedure between the first network device and the second network device, according to an embodiment of the present disclosure.

FIG. 6 is a flowchart illustrating a key selection procedure performed by a wireless device for encrypting feedback information, according to an embodiment of the present disclosure.

### DETAILED DESCRIPTION

The following description sets forth exemplary embodiments and does not limit the scope of the appended claims. Features described in connection with one embodiment may be combined with features of other embodiments. Reference throughout this specification to “one embodiment,” “an embodiment,” “certain embodiments,” or similar language means that a particular feature, structure, or characteristic described in connection with the embodiment may be included in at least one embodiment.

Reference will now be made in detail to embodiments, examples of which are illustrated in the accompanying drawings. In the following detailed description, numerous specific details are set forth to provide a thorough understanding of the various described embodiments. However, it will be apparent to one of ordinary skill in the art that the various described embodiments may be practiced without these specific details.

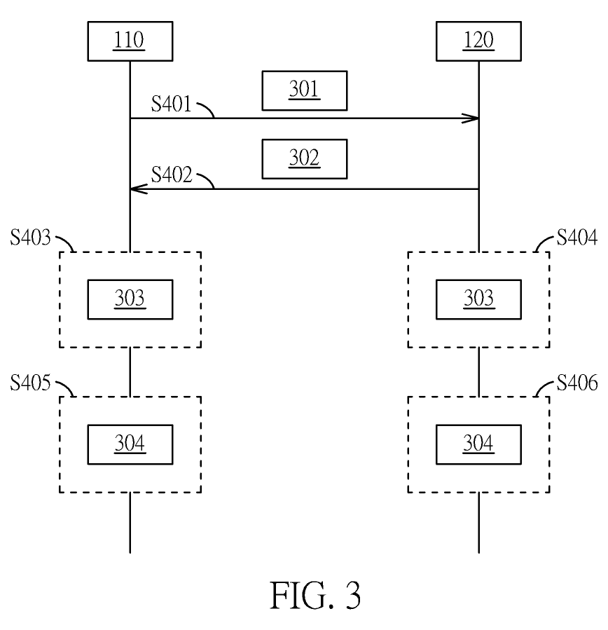

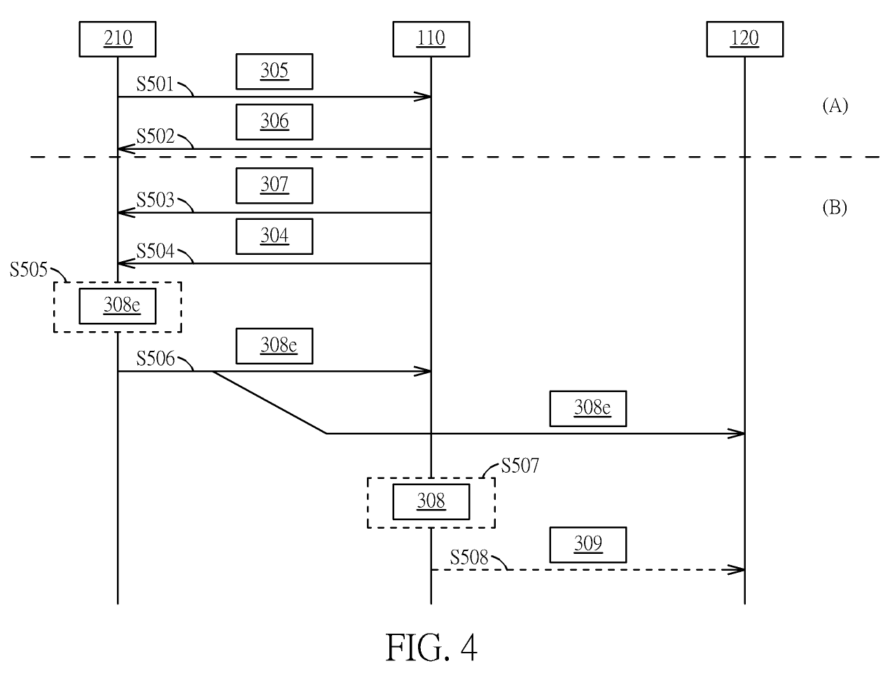

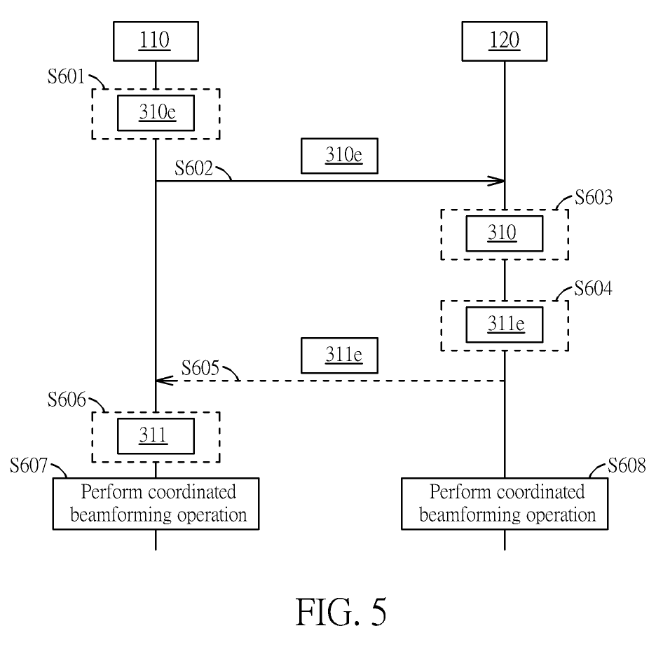

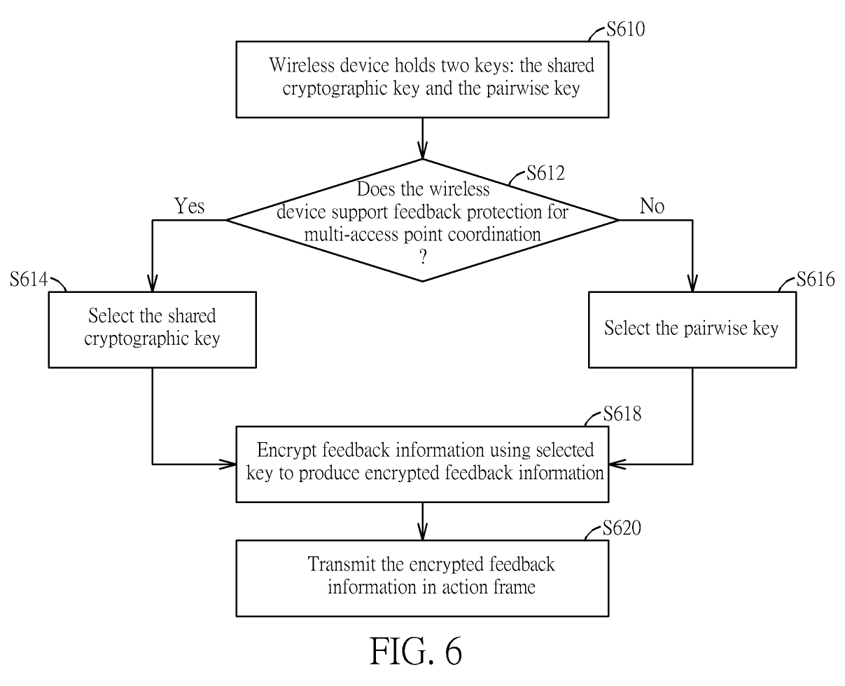

Portions of the detailed description that follows are presented and discussed in terms of a method. Although steps and sequencing thereof are disclosed in figures herein (e.g., FIG. 3, FIG. 4, FIG. 5, and FIG. 6) describing the operations of these methods, such steps and sequencing are exemplary. Embodiments may include various other steps or variations of the steps recited in the flowcharts and sequence diagrams of the figures herein, and the steps may be performed in a sequence other than the sequence depicted and described herein.

As used herein, the term “feedback protection” refers to the encryption of feedback information, transmitted by a wireless device during a channel sounding procedure, with a cryptographic key that enables decryption by multiple network devices participating in a coordinated wireless operation. A wireless device that supports feedback protection for multi-access point coordination is capable of encrypting its feedback information using a shared cryptographic key held by both a sharing AP and a shared AP, so that each network device in the coordinated operation can decrypt the feedback information.

As used herein, the term “shared cryptographic key” refers to a cryptographic key independently derived by two network devices through a key agreement procedure, such that both network devices obtain an identical key without the key itself being transmitted over a wireless channel. The shared cryptographic key is distinct from a “pairwise key,” which refers to a cryptographic key established between a wireless device and a single network device during an association procedure.

As used herein, the term "shared secrets" refers to a value that serves as an input for deriving the shared cryptographic key. The shared secrets are produced during a key establishment procedure between two network devices. During the key establishment procedure, each network device combines a private key retained by that network device with a public key received from the other network device. This combination produces the shared secrets through a key agreement protocol, such as Diffie-Hellman (DH) or elliptic-curve Diffie-Hellman (ECDH). Because of the mathematical properties of the key agreement protocol, both network devices independently arrive at the same shared secrets. The shared secrets are not transmitted over a wireless channel during this procedure. The shared secrets differ from the shared cryptographic key in that the shared secrets are not directly used as an encryption key. To obtain the shared cryptographic key, a key derivation function is applied to the shared secrets. The resulting shared cryptographic key is the key used to encrypt and decrypt communications between the two network devices.

The terms “network device” and “access point” (or “AP”) are used interchangeably herein and may refer to a wireless communication device that provides network access to associated wireless devices within a basic service set (BSS). Similarly, the terms “wireless device” and “station” (or “STA”) are used interchangeably herein and may refer to a wireless communication device that communicates with a network device.

As used herein, the term "channel sounding procedure" refers to a procedure defined in the IEEE 802.11 family of standards in which an access point (AP), operating as a beamformer, transmits a sounding signal to one or more stations, each operating as a beamformee, and each station estimates the channel response and transmits feedback information back to the access point, as described above in the Background section.

As used herein, the term "action frame" refers to a type of management frame defined in the IEEE 802.11 standard that carries information elements associated with a specific action category. In the context of the present disclosure, encrypted feedback information described with reference to FIG. 4 may be transmitted in an action frame. Under the IEEE 802.11 standard, action frames may be classified as robust action frames or non-robust action frames. A robust action frame is protected by encryption at the media access control (MAC) layer when a pairwise transient key security association exists between the transmitting device and the receiving device. A non-robust action frame is transmitted without such MAC layer encryption. In some embodiments, feedback information is encrypted at a higher layer by a wireless device using a selected cryptographic key before being carried in the action frame, regardless of whether the action frame itself is classified as robust or non-robust.

As used herein, the term "multi-access point coordination" or "M-APC" refers to a framework defined in the IEEE 802.11bn standard in which two or more access points coordinate their wireless transmissions to manage interference in overlapping coverage areas. In the IEEE 802.11bn standard, multi-access point coordination is abbreviated as "MAPC," and the abbreviation "MAPC" is used as a prefix in frame names and protocol names defined by the standard, such as MAPC Discovery Request frames, MAPC Negotiation Request frames, and MAPC PASN. The terms "M-APC" and "MAPC" are used interchangeably herein to refer to multi-access point coordination. In an M-APC configuration, one access point operates as a sharing AP that acquires a transmission opportunity (TXOP) and initiates the coordination, and another access point operates as a shared AP that participates in the coordinated operation under the direction of the sharing AP. The sharing AP and the shared AP may establish coordination agreements through MAPC Negotiation Request frames and MAPC Negotiation Response frames. The coordinated operations may include coordinated beamforming (Co-BF), in which multiple access points transmit concurrently while steering their respective beams to reduce inter-BSS interference, and coordinated spatial reuse (Co-SR), in which multiple access points transmit concurrently with adjusted transmission power levels to reduce interference within an overlap region.

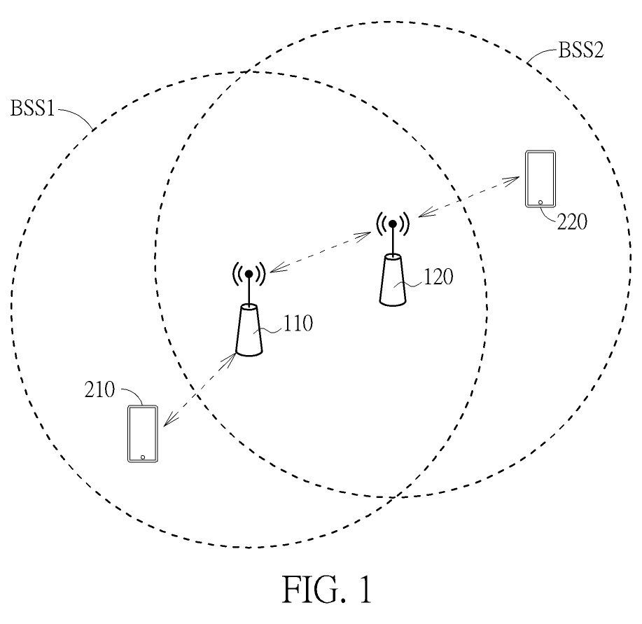

Referring now to FIG. 1, a wireless communication system according to an embodiment of the present disclosure is illustrated. The wireless communication system comprises a network device 110 and a network device 120. The network device 110 may also be referred to herein as a first network device or a sharing access point (AP), and the network device 120 may also be referred to herein as a second network device or a shared AP. The wireless communication system further comprises a wireless device 210 associated with the network device 110 and a wireless device 220 associated with the network device 120. The wireless device 210 may also be referred to herein as a first wireless device or a station (STA). In the embodiment illustrated in FIG. 1, the network device 110 and the network device 120 are configured to coordinate their wireless transmissions through multi-access point coordination (M-APC). In this M-APC configuration, the network device 110 operates as the sharing AP that initiates the coordination, and the network device 120 operates as the shared AP that participates in the coordinated operation. Although FIG. 1 illustrates one wireless device associated with each network device for clarity, in practice, each network device may serve a plurality of wireless devices within its respective basic service set. The procedures described below with reference to FIG. 3 to FIG. 6 apply to each wireless device that participates in the coordinated operation.

The network device 110 provides wireless communication services within a coverage area defined by a basic service set BSS1. The network device 120 provides wireless communication services within a coverage area defined by a basic service set BSS2. As illustrated in FIG. 1, the coverage areas of BSS1 and BSS2 partially overlap with each other, forming an overlap region. A wireless device located within the overlap region can be within the communication range of both the network device 110 and the network device 120. Accordingly, when a wireless device transmits a wireless signal from within the overlap region, both the network device 110 and the network device 120 can receive the transmission.

In the embodiment illustrated in FIG. 1, the wireless device 210 is located within BSS1 but outside the overlap region between BSS1 and BSS2. Because the wireless device 210 is located outside the coverage area of BSS2, the network device 120 cannot directly receive transmissions from the wireless device 210. This limitation impacts how channel state information is exchanged during the coordinated operations described below with reference to FIG. 3 to FIG. 5. For example, when the wireless device 210 transmits feedback information related to a channel sounding procedure, the network device 110 can receive the feedback information. However, because the network device 120 is outside the communication range of the wireless device 210, the network device 120 may not receive the feedback information. In such a scenario, the network device 110 may forward channel state information derived from the feedback information to the network device 120, as will be described further with reference to FIG. 4.

In some embodiments, the wireless device 210 may be located within the overlap region between BSS1 and BSS2 rather than outside the overlap region. In such an alternative configuration, both the network device 110 and the network device 120 can directly receive transmissions from the wireless device 210. As a result, when the wireless device 210 transmits encrypted feedback information, both the network device 110 and the network device 120 may receive the encrypted feedback information without requiring the network device 110 to forward channel state information to the network device 120.

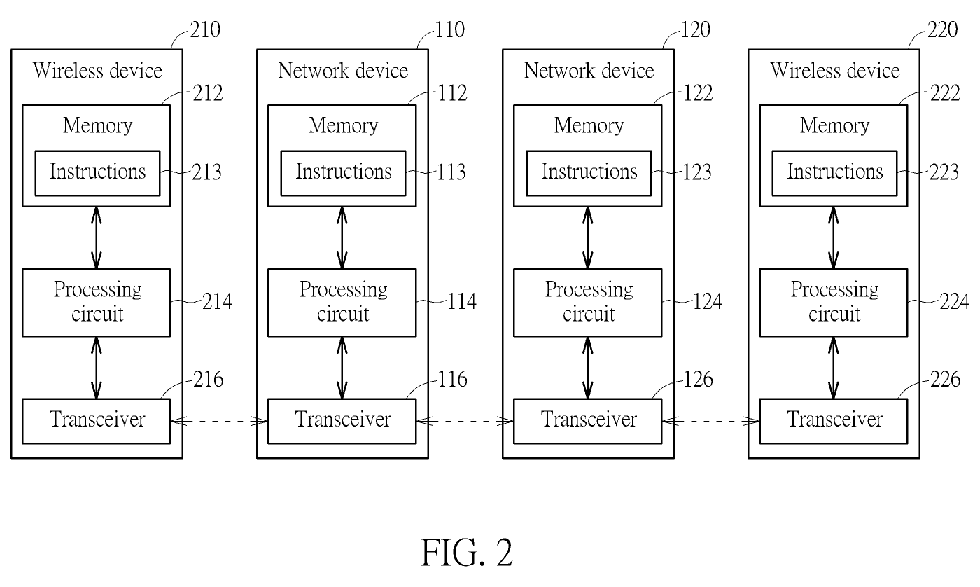

Referring now to FIG. 2, the internal components of the wireless device 210, the wireless device 220, the network device 110, and the network device 120 are illustrated. Each of the four devices comprises a memory, a processing circuit, and a transceiver. Taking the wireless device 210 as a representative example, the wireless device 210 comprises a memory 212, instructions 213 stored in the memory 212, a processing circuit 214 coupled to the memory 212, and a transceiver 216 coupled to the processing circuit 214. The memory 212 is a non-transitory computer-readable storage medium that stores the instructions 213 for execution by the processing circuit 214. The transceiver 216 is coupled to the processing circuit 214 and configured to transmit and receive wireless signals under the control of the processing circuit 214.

The processing circuit 214 may comprise one or more processors configured to execute the instructions 213 stored in the memory 212. When executed by the one or more processors, the instructions 213 cause the wireless device 210 to perform the wireless communication operations described herein, including encrypting feedback information and transmitting encrypted feedback information as described further with reference to FIG. 4 and FIG. 6. The transceiver 216 operates under the direction of the processing circuit 214 to exchange wireless signals with the network device 110 and, depending on the location of the wireless device 210, potentially with the network device 120 as described above with reference to FIG. 1. Similarly, the network device 110 comprises a memory 112 storing instructions 113, a processing circuit 114 coupled to the memory 112, and a transceiver 116 coupled to the processing circuit 114. The processing circuit 114 may comprise one or more processors configured to execute the instructions 113. When executed by the one or more processors of the network device 110, the instructions 113 cause the network device 110 to perform operations including establishing a shared cryptographic key, distributing keys, and encrypting coordination information, as described further with reference to FIG. 3 to FIG. 5.

The network device 120 comprises a memory 122 storing instructions 123, a processing circuit 124 coupled to the memory 122, and a transceiver 126 coupled to the processing circuit 124. The internal architecture of the network device 120 is configured in the same manner as that of the network device 110. The wireless device 220 comprises a memory 222 storing instructions 223, a processing circuit 224 coupled to the memory 222, and a transceiver 226 coupled to the processing circuit 224. The internal architecture of the wireless device 220 is configured in the same manner as that of the wireless device 210. Each device communicates with other devices via its respective transceiver over wireless communication channels established within BSS1 and BSS2.

In various embodiments, the memory 212 (and similarly the memories 112, 122, and 222) may be implemented as one or more of a random-access memory (RAM), a read-only memory (ROM), a flash memory, an electrically erasable programmable read-only memory (EEPROM), or other non-volatile or volatile storage media suitable for storing processor-executable instructions. The processing circuit 214 (and similarly the processing circuits 114, 124, and 224) may be implemented as one or more of a central processing unit (CPU), a microprocessor, a digital signal processor (DSP), an application-specific integrated circuit (ASIC), a field-programmable gate array (FPGA), or a combination thereof. In some embodiments, the processing circuit 214 may comprise a baseband processor configured to work with the transceiver 216 to perform physical layer (PHY) operations, including channel estimation and beamforming computations. The transceiver 216 (and similarly the transceivers 116, 126, and 226) may comprise a radio frequency (RF) front-end module comprising one or more power amplifiers, low-noise amplifiers, mixers, and analog-to-digital or digital-to-analog converters for transmitting and receiving wireless signals in compliance with one or more IEEE 802.11 standards, such as IEEE 802.11bn. In some embodiments, each transceiver may comprise multiple antenna elements to support multi-user multiple-input multiple-output (MU-MIMO) operations, including channel sounding and coordinated beamforming as described further with reference to FIG. 4 and FIG. 5.

Referring now to FIG. 3, a key establishment procedure between the network device 110 and the network device 120 according to an embodiment of the present disclosure is illustrated. As described above with reference to FIG. 1, the network device 110 and the network device 120 are configured to perform multi-access point coordination (M-APC), in which the two network devices coordinate their wireless transmissions. Before any coordinated operation can proceed, the network device 110 and the network device 120 establish a shared cryptographic key 304 that protects communications exchanged between them. FIG. 3 depicts the sequence of operations through which the network device 110 and the network device 120 exchange security information and derive the shared cryptographic key 304. The procedure illustrated in FIG. 3 is performed prior to Phase (B) of FIG. 4 and the operations described below with reference to FIG. 5. Phase (A) of FIG. 4 describes the association of the wireless device 210 with the network device 110. Phase (A) may occur before, after, or concurrently with the procedure of FIG. 3. This flexibility in timing is possible because the association of the wireless device 210 with the network device 110 and the key establishment between the network device 110 and the network device 120 are two independent procedures.

At step S401, the network device 110 transmits security information 301 to the network device 120. In the embodiment illustrated in FIG. 3, the security information 301 comprises a public key of the network device 110. The public key included in the security information 301 is a cryptographic value generated by the network device 110 and can be shared with another device without compromising the security of a corresponding private key retained by the network device 110. At step S402, the network device 120 transmits security information 302 to the network device 110 in return. The security information 302 comprises a public key of the network device 120. Similarly, the public key included in the security information 302 is generated by the network device 120, and a corresponding private key of the network device 120 remains internal to the network device 120. Through steps S401 and S402, the network device 110 and the network device 120 complete a mutual exchange of the security information 301 and the security information 302. The order in which steps S401 and S402 are performed may be reversed in other embodiments, as long as both the security information 301 and the security information 302 are exchanged between the two network devices.

At step S403, the network device 110 derives shared secrets 303 based on the public key included in the received security information 302 and the private key of the network device 110. The derivation at step S403 may employ a key agreement protocol such as Diffie-Hellman (DH) or elliptic-curve Diffie-Hellman (ECDH), in which each network device combines a private key retained by that network device with a public key received from the other network device to produce a common value. At step S404, the network device 120 independently derives the shared secrets 303 based on the public key included in the received security information 301 and the private key of the network device 120. Due to the mathematical properties of the underlying key agreement protocol, the shared secrets 303 derived by the network device 110 at step S403 are identical to the shared secrets 303 derived by the network device 120 at step S404, even though neither network device has access to the other network device's private key. The shared secrets 303 are derived directly from the key agreement protocol and are distinct from the shared cryptographic key 304 described below.

At step S405, the network device 110 derives the shared cryptographic key 304 from the shared secrets 303. The derivation at step S405 may apply a key derivation function to the shared secrets 303 to produce the shared cryptographic key 304 suitable for encrypting and decrypting wireless communication frames. At step S406, the network device 120 independently derives the shared cryptographic key 304 from the shared secrets 303 using the same key derivation function. Because the shared secrets 303 held by the network device 110 and the network device 120 are identical, the shared cryptographic key 304 derived at step S405 by the network device 110 and the shared cryptographic key 304 derived at step S406 by the network device 120 are also identical. Following steps S405 and S406, both the network device 110 and the network device 120 hold the same shared cryptographic key 304. The shared cryptographic key 304 itself is not transmitted over a wireless channel at any point during this procedure. The shared cryptographic key 304 is subsequently used to protect coordination information exchanged between the network device 110 and the network device 120, as described with reference to FIG. 5, and is further distributed to the wireless device 210 for encrypting feedback information, as described with reference to FIG. 4.

In some embodiments, the exchange of security information at steps S401 and S402 may be carried out through a multi-AP coordination pre-association security negotiation (MAPC PASN) protocol. Under the MAPC PASN protocol, the network device 110 and the network device 120 exchange a plurality of authentication frames to establish a pairwise transient key security association (PTKSA) between the network device 110 and the network device 120. In one implementation, three MAPC Authentication frames are exchanged between the network device 110 and the network device 120, where each MAPC Authentication frame is a Public Action frame carrying an authentication algorithm number indicating MAPC PASN authentication. The network device 110 may operate as a MAPC requesting AP that initiates the MAPC PASN procedure, and the network device 120 may operate as a MAPC responding AP.

In the first MAPC Authentication frame, the network device 110 transmits a Robust Security Network element (RSNE) and a PASN Parameters element to the network device 120. The first MAPC Authentication frame further includes an RSN Extension element (RSNXE) if at least one capability field of the RSNXE is set to a nonzero value. In some embodiments, a capability field within the RSNXE carried in the MAPC Authentication frame may indicate whether the transmitting network device supports feedback protection in the context of M-APC. This feedback protection capability field within the MAPC Authentication frame is an extension proposed by the present disclosure and is not defined in existing standards at the time of this disclosure. The inclusion of such a capability field in the RSNXE of a MAPC Authentication frame is implementation-specific. In alternative embodiments, the network device 110 and the network device 120 may negotiate feedback protection support through other signaling mechanisms, such as a dedicated information element within the MAPC Discovery Request frame or the MAPC Discovery Response frame, or through a vendor-specific element carried in the MAPC Authentication frame. The PASN Parameters element may carry an ephemeral public key of the network device 110, which is included in the security information 301 of FIG. 3.

In one embodiment, the RSNXE included in the MAPC Authentication frame at step S401 may contain a feedback protection capability field. This feedback protection capability field indicates to the network device 120 whether the network device 110 supports feedback protection. When present, this feedback protection capability field is exchanged between two network devices during the MAPC PASN procedure. This feedback protection capability field is distinct from a separate capability indication transmitted by the wireless device 210 to a network device during an association procedure, as described below with reference to FIG. 4. Specifically, the capability indication in FIG. 4 is transmitted from a wireless device to a network device during an association procedure to indicate whether the wireless device supports feedback protection for multi-access point coordination. By contrast, the feedback protection capability field in the MAPC Authentication frame is exchanged between two network devices during the MAPC PASN procedure.

In the second MAPC Authentication frame, the network device 120 responds with a corresponding RSNE, a PASN Parameters element carrying an ephemeral public key of the network device 120 (which is included in the security information 302 of FIG. 3), and a message integrity code (MIC) element for confirming the authentication. In the third MAPC Authentication frame, the network device 110 transmits a PASN Parameters element and a MIC element to confirm the authentication. Upon completion of the three-frame exchange, both the network device 110 and the network device 120 derive the shared secrets 303 and the shared cryptographic key 304 from the exchanged ephemeral public keys, as described above with reference to steps S403 to S406.

The MAPC PASN procedure described above follows a pre-association security negotiation protocol adapted for M-APC. In the MAPC PASN procedure, the roles defined in the base PASN procedure are adapted for inter-AP communications. Specifically, in the MAPC PASN procedure, the MAPC requesting AP takes the role of the non-AP station as defined in the base PASN procedure, and the MAPC responding AP takes the role of the AP as defined in the base PASN procedure. The MAPC PASN protocol may further support mutual authentication between the network device 110 and the network device 120. This mutual authentication is available when a pairwise master key security association (PMKSA) has been previously established between the two network devices using an authentication and key management protocol (AKMP), such as simultaneous authentication of equals (SAE). The MAPC PASN procedure and the three-frame exchange described above are one embodiment of exchanging security information between the network device 110 and the network device 120. In alternative embodiments, the security information 301, 302 may be exchanged using other frame types or protocols, and the number of frames exchanged may differ.

The key establishment procedure of FIG. 3 addresses a technical challenge that arises in M-APC environments. In a wireless communication system employing MU-MIMO, a wireless device, such as the wireless device 210, may transmit channel state information (CSI) as feedback to an access point during a channel sounding procedure. In some approaches, such feedback information may be transmitted without encryption or may be encrypted using a pairwise key that is established between the wireless device and its associated access point during an association procedure. However, in an M-APC scenario where both the network device 110 (sharing AP) and the network device 120 (shared AP) participate in coordinated transmissions, the pairwise key established between the wireless device 210 and the network device 110 may not be available to the network device 120. As a result, even if the wireless device 210 encrypts its feedback information using the pairwise key, the network device 120 may not be able to decrypt the feedback information and may therefore be unable to use the channel state information for coordinated beamforming. The shared cryptographic key 304 established through the procedure of FIG. 3 is held by both the network device 110 and the network device 120. When the wireless device 210 encrypts feedback information using the shared cryptographic key 304, either network device can decrypt the encrypted feedback information. The use of the shared cryptographic key 304 for encrypting and decrypting feedback information is described further with reference to FIG. 4 and FIG. 6.

The shared cryptographic key 304 established through the procedure of FIG. 3 is different from a pairwise key that may be established between a wireless device and a network device during an association procedure. For example, the shared cryptographic key 304 is different from the pairwise key established between the wireless device 210 and the network device 110 (described below as pairwise key 306 with reference to FIG. 4). The shared cryptographic key 304 is derived from security information exchanged between the network device 110 and the network device 120, whereas the pairwise key 306 is derived from security information exchanged between the wireless device 210 and the network device 110. In one approach, a network device could share the pairwise key of its associated wireless device with another network device. However, such an approach would expose the pairwise key to a device that did not participate in the association procedure through which the pairwise key was originally established. This sharing could weaken the security separation between independent network devices operating in different basic service sets. By contrast, in the embodiment of FIG. 3, the network device 110 and the network device 120 derive the shared cryptographic key 304 through an independent key agreement procedure without exchanging any existing pairwise key between them. This arrangement maintains the separation between the pairwise key used within each basic service set and the shared cryptographic key used for inter-AP coordination and for decrypting feedback information across basic service sets.

Referring now to FIG. 4, a procedure for encrypted feedback in an M-APC scenario according to an embodiment of the present disclosure is illustrated. The procedure involves the wireless device 210, the network device 110, and the network device 120 described above with reference to FIG. 1 and FIG. 2. FIG. 4 depicts two phases: a Phase (A), which occurs during an association stage in which the wireless device 210 associates with the network device 110, and a Phase (B), which occurs during M-APC operations in which the network device 110 and the network device 120 coordinate their wireless transmissions. During Phase (A), the wireless device 210 and the network device 110 exchange capability information and establish a pairwise key. During Phase (B), the network device 110 distributes a shared cryptographic key to the wireless device 210, and the wireless device 210 uses the shared cryptographic key to encrypt feedback information for transmission. The shared cryptographic key 304 used in Phase (B) is the same shared cryptographic key 304 established between the network device 110 and the network device 120 through the key establishment procedure described above with reference to FIG. 3.

In Phase (A), at step S501, the wireless device 210 transmits a capability indication 305 to the network device 110. The capability indication 305 indicates whether the wireless device 210 supports feedback protection for multi-access point coordination. The term "feedback protection" is defined above in the Detailed Description. In one embodiment, the capability indication 305 is carried in a Robust Security Network Extension element (RSNXE) as a feedback protection field. When the feedback protection field is set to a first value (e.g., 1), the capability indication 305 indicates that the wireless device 210 supports encrypting feedback information using a key shared among multiple access points in an M-APC scenario. When the feedback protection field is set to a second value (e.g., 0), the capability indication 305 indicates that the wireless device 210 supports encrypting feedback information for single-AP communications only. The capability indication 305 transmitted at step S501 informs the network device 110 of the encryption capability of the wireless device 210. Based on the capability indication 305, the network device 110 determines whether to distribute the shared cryptographic key 304 to the wireless device 210 for use in subsequent M-APC operations.

At step S502, the network device 110 and the wireless device 210 establish a pairwise key 306 during an association procedure. The pairwise key 306 is a cryptographic key established between the wireless device 210 and the network device 110 based on security information exchanged during the association of the wireless device 210 with the network device 110. During the association procedure at step S502, the wireless device 210 and the network device 110 exchange key material and each derive the pairwise key 306 from the exchanged key material. As a result of this key material exchange, both the wireless device 210 and the network device 110 obtain the pairwise key 306. The pairwise key 306 enables the wireless device 210 and the network device 110 to encrypt and decrypt communications exchanged between them. The pairwise key 306 is different from the shared cryptographic key 304, as described above with reference to FIG. 3. In some embodiments, the order of steps S501 and S502 within Phase (A) may be different from the order illustrated in FIG. 4, and steps S501 and S502 may occur in any order or concurrently during the association stage.

Phase (B) begins after both the association of the wireless device 210 with the network device 110 in Phase (A) and the key establishment between the network device 110 and the network device 120 in FIG. 3 have been completed. Specifically, Phase (B) requires that the pairwise key 306 has been established between the wireless device 210 and the network device 110 at step S502, and that the shared cryptographic key 304 has been derived by both the network device 110 and the network device 120 at steps S405 and S406 of FIG. 3. Once both conditions are met, Phase (B) proceeds as follows. At step S503, the network device 110 transmits coordination information 307 to the wireless device 210. The coordination information 307 indicates that the network device 110 is operating in a coordinated mode with the network device 120. For example, the coordination information 307 may indicate that the network device 110 (sharing AP) and the network device 120 (shared AP) are participating in a coordinated wireless operation such as coordinated beamforming or coordinated spatial reuse. The coordination information 307 notifies the wireless device 210 of the coordinated mode so that the wireless device 210 can encrypt its feedback information using a key that is accessible to both the network device 110 and the network device 120.

The coordination information 307 transmitted from the network device 110 to the wireless device 210 may also be referred to herein as a coordination mode indication. The coordination mode indication 307 notifies the wireless device 210 that the network device 110 is currently operating in a coordinated mode with the network device 120. The coordination mode indication 307 is distinct from the coordination information 310 and the coordination information 311 exchanged between the two network devices in FIG. 5, which are transmitted in negotiation frames for establishing parameters of the coordinated wireless operation.

At step S504, the network device 110 transmits the shared cryptographic key 304 to the wireless device 210. The shared cryptographic key 304 transmitted at step S504 is the shared cryptographic key 304 established between the network device 110 and the network device 120 at steps S405 and S406 of FIG. 3. By transmitting the shared cryptographic key 304 to the wireless device 210, the network device 110 provides the wireless device 210 with the cryptographic key enabling the wireless device 210 to produce encrypted feedback information that is decodable by both the network device 110 and the network device 120. The transmission of the shared cryptographic key 304 at step S504 is protected using the pairwise key 306 established between the network device 110 and the wireless device 210 at step S502. Because the pairwise key 306 is known only to the network device 110 and the wireless device 210, the shared cryptographic key 304 is not accessible to unauthorized devices during the distribution at step S504.

In some embodiments, the shared cryptographic key 304 may be carried in a management frame that is encrypted using the pairwise key 306. In other embodiments, the shared cryptographic key 304 may be distributed to the wireless device 210 using one of the following approaches: an extension of the association procedure, a dedicated key distribution element included in a protected action frame, or a group key handshake mechanism adapted for multi-access point coordination. The specific frame type and information element used for the distribution of the shared cryptographic key 304 may depend on the implementation and the applicable standard revision. In each case, the distribution is protected by the pairwise key 306 as described above. In some embodiments, the order of steps S503 and S504 may be different from the order illustrated in FIG. 4, or steps S503 and S504 may be performed concurrently, for example within a single management frame that carries both the coordination information 307 and the shared cryptographic key 304.

At step S505, the wireless device 210 encrypts feedback information 308 to produce encrypted feedback information 308e. The feedback information 308 comprises channel state information associated with a communication channel between the wireless device 210 and the network device 110. The feedback information 308 further comprises beamforming feedback angles associated with the communication channel. The channel state information and the beamforming feedback angles within the feedback information 308 represent measurements performed by the wireless device 210 during a channel sounding procedure, in which the network device 110 transmits a sounding signal (such as a null data packet) and the wireless device 210 estimates the channel response and computes corresponding feedback parameters. The channel state information and the beamforming feedback angles within the feedback information 308 are obtained through the channel sounding procedure described above in the Background section, in which the network device 110 transmits a null data packet announcement (NDPA) frame followed by a null data packet (NDP), and the wireless device 210 estimates the channel frequency response and computes quantized beamforming feedback angles.

The network device 110 may solicit the feedback information 308 by transmitting a beamforming report poll (BFRP) trigger frame after the NDP. In response, the wireless device 210 transmits the encrypted feedback information 308e in a trigger-based physical layer protocol data unit (TB PPDU). The network device 110 recovers the beamforming feedback matrix from the decrypted beamforming feedback angles and uses the reconstructed matrix, together with signal-to-noise ratio (SNR) information, to compute a steering matrix for the coordinated beamforming operation described with reference to FIG. 5.

The encryption at step S505 involves a key selection operation in which the wireless device 210 selects either the pairwise key 306 or the shared cryptographic key 304 for encrypting the feedback information 308. Following the selection, the wireless device 210 applies the selected key to encrypt the feedback information 308 and produces the encrypted feedback information 308e. The key selection logic at step S505 is described in further detail below with reference to FIG. 6.

At step S506, the wireless device 210 transmits the encrypted feedback information 308e via the transceiver 216. In one embodiment, the encrypted feedback information 308e is transmitted in an action frame. Because the network device 110 is the access point with which the wireless device 210 is associated, the network device 110 receives the encrypted feedback information 308e at step S506 via the transceiver 116. In some embodiments, when the wireless device 210 is located within the overlap region between BSS1 and BSS2, rather than outside the overlap region as illustrated in FIG. 1, the network device 120 may also directly receive the encrypted feedback information 308e at step S506.

At step S507, the network device 110 decrypts the encrypted feedback information 308e to obtain the feedback information 308. The key used by the network device 110 for the decryption at step S507 is the same as the key used by the wireless device 210 for the encryption at step S505. When the wireless device 210 has encrypted the feedback information 308 using the shared cryptographic key 304 at step S505, the network device 110 uses the same shared cryptographic key 304 to perform the decryption at step S507. When the wireless device 210 has instead encrypted the feedback information 308 using the pairwise key 306 at step S505, the network device 110 uses the pairwise key 306 to perform the decryption at step S507.

The network device 110 may determine which key was used by the wireless device 210 based on the capability indication 305 received at step S501. For example, when the capability indication 305 indicates that the wireless device 210 supports feedback protection for multi-access point coordination, the network device 110 may determine that the wireless device 210 used the shared cryptographic key 304 for encryption. When the capability indication 305 indicates that the wireless device 210 does not support feedback protection for multi-access point coordination, the network device 110 may determine that the wireless device 210 used the pairwise key 306 for encryption. In some embodiments, the network device 110 may alternatively determine which key was used by the wireless device 210 through one of the following approaches: (i) based on an indication carried in the action frame containing the encrypted feedback information 308e, or (ii) by attempting decryption with one key first and retrying with the other key if the first decryption attempt fails. In either case, the network device 110 recovers the feedback information 308, including the channel state information and the beamforming feedback angles, from the encrypted feedback information 308e. The channel state information recovered at step S507 is subsequently used by the network device 110 for the coordinated wireless operation described below with reference to FIG. 5.

At step S508, the network device 110 forwards channel state information 309 to the network device 120 for use in the coordinated wireless operation. The channel state information 309 forwarded at step S508 is derived from the feedback information 308 obtained by the network device 110 at step S507. The forwarding at step S508 is protected using the shared cryptographic key 304 established between the network device 110 and the network device 120 through the procedure of FIG. 3. By encrypting the channel state information 309 with the shared cryptographic key 304 during the forwarding, the network device 110 prevents unauthorized capture or change of the channel state information during inter-AP transmission. The network device 120 decrypts the forwarded channel state information 309 using the same shared cryptographic key 304. In the embodiment illustrated in FIG. 1, the wireless device 210 is located within BSS1 but outside the overlap region between BSS1 and BSS2, and therefore the network device 120 cannot directly receive transmissions from the wireless device 210. In such a configuration, the forwarding at step S508 provides the network device 120 with the channel state information for use in the coordinated wireless operation. In some embodiments, when the wireless device 210 is located within the overlap region, rather than outside the overlap region as illustrated in FIG. 1, the network device 120 may directly receive the encrypted feedback information 308e at step S506 and may decrypt the encrypted feedback information 308e using the shared cryptographic key 304 to obtain the channel state information. In such a case, step S508 may be omitted. Regardless of whether the network device 120 obtains the channel state information through the forwarding at step S508 or through direct reception at step S506, the network device 120 uses the obtained channel state information for the coordinated wireless operation described below with reference to FIG. 5.

Although FIG. 4 describes the encrypted feedback procedure with respect to the wireless device 210 and the network device 110, the same procedure applies to any wireless device participating in the coordinated wireless operation. For example, the wireless device 220 (see FIG. 1) may perform the same procedure with the network device 120, and the network device 120 may forward the resulting channel state information to the network device 110.

Referring now to FIG. 5, the network device 110 and the network device 120 use the shared cryptographic key 304 established through the procedure of FIG. 3 to encrypt and decrypt coordination information exchanged between them during an M-APC negotiation procedure. Following the encrypted negotiation, the network device 110 and the network device 120 perform a coordinated wireless operation based on the channel state information obtained through the procedure described above with reference to FIG. 4.

At step S601, the network device 110 encrypts coordination information 310 using the shared cryptographic key 304 to produce encrypted coordination information 310e. The coordination information 310 is associated with a coordinated wireless operation involving the network device 110 and the network device 120. In one embodiment, the coordination information 310 is transmitted in a negotiation request frame, such as a MAPC Negotiation Request frame. Through the negotiation request frame, the network device 110 proposes parameters for the coordinated wireless operation to the network device 120. The parameters carried in the coordination information 310 may include, for example, proposed beamforming configurations, transmission power levels, resource allocation information, or scheduling parameters for the coordinated wireless operation. The encryption at step S601 protects the coordination information 310 from unauthorized interception or modification during transmission between the network device 110 and the network device 120. At step S602, the network device 110 transmits the encrypted coordination information 310e to the network device 120. At step S603, the network device 120 receives the encrypted coordination information 310e and decrypts the encrypted coordination information 310e using the shared cryptographic key 304, and obtains the coordination information 310. The network device 120 recovers the coordination information 310 from the encrypted coordination information 310e using the shared cryptographic key 304.

At step S604, the network device 120 encrypts coordination information 311 using the shared cryptographic key 304 to produce encrypted coordination information 311e. The coordination information 311 is transmitted in a negotiation response frame, such as a MAPC Negotiation Response frame. Through the negotiation response frame, the network device 120 communicates acceptance, rejection, or modification of the parameters proposed in the coordination information 310. At step S605, the network device 120 transmits the encrypted coordination information 311e to the network device 110. At step S606, the network device 110 decrypts the encrypted coordination information 311e using the shared cryptographic key 304, and obtains the coordination information 311. Through the exchange at steps S601 to S606, the network device 110 and the network device 120 complete a negotiation for the coordinated wireless operation in which both the negotiation request and the negotiation response are encrypted using the shared cryptographic key 304. The coordination information 310 and the coordination information 311 exchanged between the network device 110 and the network device 120 in FIG. 5 carry parameters for the coordinated wireless operation negotiated between the two network devices.

At steps S607 and S608, the network device 110 and the network device 120 perform a coordinated beamforming operation based on the parameters negotiated through the exchange of the coordination information 310 and the coordination information 311. In the coordinated beamforming operation, the network device 110 and the network device 120 perform concurrent transmissions to their respective associated wireless devices. For example, the network device 110 transmits to the wireless device 210 and the network device 120 transmits to the wireless device 220, where each network device computes its beamforming weights to minimize interference to the wireless device associated with the other network device.

In one embodiment operating in accordance with the IEEE 802.11bn standard, the coordinated beamforming operation at steps S607 and S608 proceeds as follows. In the coordinated beamforming operation, disjoint subsets of spatial streams are transmitted from the network device 110 and the network device 120, where each network device transmits a respective subset of spatial streams to its associated wireless devices. Each network device computes a steering matrix for its respective subset of spatial streams using the beamforming feedback matrices and SNR information from the participating wireless devices. The network device 110 computes the steering matrix such that the spatial streams directed to the wireless device 210 minimize the interference level at the wireless device 220, thereby reducing inter-BSS interference. Similarly, the network device 120 computes the steering matrix such that the spatial streams directed to the wireless device 220 minimize the interference level at the wireless device 210. Because the network device 120 computes the steering matrix based on the channel state information associated with the wireless device 210, the network device 120 can direct the spatial streams toward the wireless device 220 while avoiding beam directions that would cause interference at the wireless device 210. The resulting beam separation between the transmissions from the network device 110 and the transmissions from the network device 120 reduces signal degradation at both the wireless device 210 and the wireless device 220, and improves the communication quality between the network device 120 and the wireless device 220 during the concurrent transmissions.

In one embodiment operating in accordance with the IEEE 802.11bn standard, before performing the concurrent transmissions, the network device 110, operating as the Co-BF coordinating AP, transmits a Co-BF Invite frame to the network device 120, operating as the Co-BF coordinated AP. The Co-BF Invite frame is a beamforming report poll (BSRP) non-trigger-based (NTB) trigger frame that solicits a Co-BF Response frame from the network device 120. The network device 120 responds with a Co-BF Response frame, which is a Multi-STA BlockAck frame, indicating acceptance or rejection of the Co-BF invitation. When the Co-BF invitation is accepted, the network device 110 transmits a Co-BF Trigger frame to the network device 120. The Co-BF Trigger frame carries synchronization parameters including the duration of the data physical layer protocol data units (PPDUs), the bandwidth, the preamble structure, and per-user parameters for the coordinated beamforming transmission. In response to the Co-BF Trigger frame, both the network device 110 and the network device 120 transmit their respective data PPDUs simultaneously, where the data PPDUs share a common preamble structure. The concurrent data PPDUs transmitted by the two network devices are received by their respective associated wireless devices for decoding.

The coordinated beamforming operation at steps S607 and S608 relies on the channel state information obtained through the procedure of FIG. 4, as described above with reference to steps S507 and S508.

In the embodiment illustrated in FIG. 5, the coordinated wireless operation is described as a coordinated beamforming operation. In other embodiments, the coordinated wireless operation may comprise a coordinated spatial reuse operation. In a coordinated spatial reuse operation, the network device 110 and the network device 120 perform concurrent transmissions. During the concurrent transmissions, one or both of the network devices adjust their respective transmission power based on the channel state information in order to reduce interference within the overlap region between BSS1 and BSS2. For example, the network device 120 may reduce its transmission power to shrink the effective coverage area of BSS2, thereby reducing the overlap region with BSS1 and reducing interference to wireless devices associated with the network device 110. By adjusting the transmission power based on the channel state information associated with the wireless device 210, the network device 120 can determine a transmission power level that avoids excessive interference at the wireless device 210 while maintaining communication quality with the wireless device 220. The reduced overlap region and the adjusted transmission power allow the network device 120 to transmit to the wireless device 220 with less interference from the network device 110, improving the throughput and reliability of the communications between the network device 120 and the wireless device 220. In one embodiment operating in accordance with the IEEE 802.11bn standard, the network device 110, operating as a Co-SR coordinating AP, determines a transmission power limit for the network device 120, operating as a Co-SR coordinated AP. The transmission power limit may be negotiated during the exchange of the coordination information 310 and the coordination information 311 at steps S601 to S606, where the coordination information 310 or the coordination information 311 carries a minimum acceptable transmission power level for the network device 120. Before performing the concurrent transmissions at steps S607 and S608, the network device 110 transmits a Co-SR Invite frame to the network device 120. The Co-SR Invite frame carries parameters including the intended number of data OFDM symbols and the PHY version of the Co-SR transmission. The network device 120 responds with a Co-SR Response frame indicating acceptance or rejection of the Co-SR invitation. When the Co-SR invitation is accepted, the network device 110 transmits a Co-SR Trigger frame to the network device 120. The Co-SR Trigger frame carries the determined transmission power limit for the network device 120 and the transmission power level of the network device 110. In response to the Co-SR Trigger frame, the network device 120 transmits a data PPDU with its transmission power set at or below the transmission power limit indicated in the Co-SR Trigger frame. The resulting concurrent transmissions from the network device 110 and the network device 120 may use different modulation and coding schemes and different numbers of spatial streams, and the data PPDUs transmitted by the two network devices start and end simultaneously. The coordination information 310 and the coordination information 311 exchanged at steps S601 to S606 may carry parameters for either the coordinated beamforming operation or the coordinated spatial reuse operation, and the encryption of the coordination information 310 and the coordination information 311 using the shared cryptographic key 304 applies regardless of which type of coordinated wireless operation is negotiated.

Referring now to FIG. 6, a key selection procedure performed by the wireless device 210 according to an embodiment of the present disclosure is illustrated. FIG. 6 provides further detail of the encryption operation at step S505 of FIG. 4. As described above with reference to FIG. 4, the wireless device 210 encrypts feedback information 308 at step S505 to produce encrypted feedback information 308e. The encryption at step S505 involves selecting one of two cryptographic keys, and FIG. 6 illustrates the decision logic by which the wireless device 210 determines which key to use. The key selection procedure of FIG. 6 begins at step S610 and concludes at step S620, after which the procedure continues at step S506 of FIG. 4.

At step S610, the wireless device 210 holds two cryptographic keys: the shared cryptographic key 304 received from the network device 110 at step S504 of FIG. 4, and the pairwise key 306 established with the network device 110 at step S502 of FIG. 4. As described above, these two keys are established through independent procedures involving different pairs of devices.

At step S612, the wireless device 210 determines whether it supports feedback protection for multi-access point coordination and whether the shared cryptographic key 304 has been received from the network device 110. In one embodiment, the wireless device 210 evaluates two conditions: first, whether the capability indication 305 that the wireless device 210 previously transmitted to the network device 110 at step S501 of FIG. 4 indicates support for feedback protection for multi-access point coordination; and second, whether the wireless device 210 currently holds the shared cryptographic key 304 distributed by the network device 110 at step S504 of FIG. 4. When both conditions are satisfied, the wireless device 210 proceeds to step S614 along the "Yes" branch of the decision at step S612. When either condition is not satisfied, for example, when the wireless device 210 does not support feedback protection for multi-access point coordination, or when the network device 110 has not yet distributed the shared cryptographic key 304 to the wireless device 210, the wireless device 210 proceeds to step S616 along the "No" branch. In alternative embodiments, the wireless device 210 may select one of the two keys based on other criteria, such as an indication received from the network device 110 or a policy configured at the wireless device 210. The decision at step S612 illustrated in FIG. 6 represents one embodiment of the key selection logic, and the selection criteria in alternative embodiments are not limited to the capability indication 305.

If the wireless device 210 supports feedback protection for multi-access point coordination (Yes at step S612), the wireless device 210 selects the shared cryptographic key 304 at step S614. By selecting the shared cryptographic key 304, the wireless device 210 enables both the network device 110 and the network device 120 to decrypt the resulting encrypted feedback information using the shared cryptographic key 304 that both network devices hold. If the wireless device 210 does not support feedback protection for multi-access point coordination (No at step S612), the wireless device 210 selects the pairwise key 306 at step S616. Because the pairwise key 306 is established between the wireless device 210 and the network device 110, the resulting encrypted feedback information is decodable by the network device 110 but not by the network device 120. In this case, the network device 120 relies on the network device 110 to forward the channel state information at step S508 of FIG. 4.

At step S618, the wireless device 210 encrypts the feedback information 308 using the key selected at step S614 or step S616 to produce the encrypted feedback information 308e. At step S620, the wireless device 210 transmits the encrypted feedback information 308e in an action frame. The procedure then continues at step S506 of FIG. 4, where the network device 110 receives the encrypted feedback information 308e and, in embodiments where the wireless device 210 is located within the overlap region, the network device 120 may also receive the encrypted feedback information 308e.

In alternative embodiments, the key agreement protocol used for deriving the shared secrets 303 at steps S403 and S404 of FIG. 3 may employ various cryptographic primitives. For example, the network device 110 and the network device 120 may use elliptic-curve Diffie-Hellman (ECDH) over a NIST P-256 curve, a finite-field Diffie-Hellman (DH) group, or other key agreement protocols. The key derivation function applied at steps S405 and S406 may employ an HMAC-based key derivation function (HKDF) as specified in RFC 5869, or other pseudorandom function families. The selection of specific cryptographic primitives may depend on the security policy and the applicable standard revision.

In alternative embodiments, the distribution of the shared cryptographic key 304 from the network device 110 to the wireless device 210 at step S504 of FIG. 4 may employ various frame types and mechanisms. For example, the shared cryptographic key 304 may be distributed through an extension of the four-way handshake procedure, a dedicated key distribution element carried in a protected management frame, a group key handshake mechanism adapted for multi-access point coordination, or other key distribution protocols. The specific mechanism may vary depending on the implementation and the applicable standard revision. In each case, the distribution is protected using the pairwise key 306.

In alternative embodiments, the coordinated wireless operation described with reference to FIG. 5 is not limited to coordinated beamforming or coordinated spatial reuse. The coordinated wireless operation may comprise other multi-AP coordination schemes, such as coordinated time division multiple access (Co-TDMA), in which a coordinating AP shares a portion of its transmission opportunity (TXOP) with a coordinated AP. The encryption of coordination information using the shared cryptographic key 304 applies regardless of the specific multi-AP coordination scheme employed.

In some embodiments, the network device 110 and the network device 120 may periodically re-execute the key establishment procedure of FIG. 3 to derive a new shared cryptographic key 304. The re-execution may be triggered by a timer expiration, a security policy change, or a teardown and re-establishment of the M-APC agreement. When a new shared cryptographic key 304 is derived, the network device 110 may distribute the new shared cryptographic key to the wireless device 210, and subsequent feedback encryption by the wireless device 210 uses the new shared cryptographic key.

In some embodiments, the capability indication 305 described with reference to FIG. 4 may be carried in an information element other than the RSNXE. For example, the capability indication 305 may be carried in a vendor-specific element, a dedicated multi-AP coordination capability element, or another information element within the association request frame or probe request frame. The specific frame type and information element used for the capability indication may depend on the applicable standard revision.

In some embodiments, the wireless communication system described herein operates in accordance with the IEEE 802.11bn (Wi-Fi^{®} 8) standard, which defines the ultra high reliability (UHR) amendment to the IEEE 802.11 family of standards. In other embodiments, the methods and apparatus described herein may be applied to wireless communication systems operating in accordance with earlier generations of the IEEE 802.11 standard. For example, the channel sounding procedure, the beamforming feedback protection, and the key selection mechanism described herein may be implemented in a wireless communication system operating in accordance with IEEE 802.11be (Wi-Fi^{®} 7), IEEE 802.11ax (Wi-Fi^{®} 6E or Wi-Fi^{®} 6), or IEEE 802.11ac (Wi-Fi^{®} 5), provided that the network devices in the system support multi-user multiple-input multiple-output (MU-MIMO) transmissions and that the applicable standard revision defines or accommodates the multi-AP coordination procedures and the key management procedures described herein. The specific frame formats, information element field definitions, key derivation parameters, and sounding sequences may differ between standard revisions.

The present disclosure addresses technical problems arising specifically in wireless communication systems employing multi-access point coordination. The disclosed solution addresses a problem specific to wireless communication technology because the vulnerability exploited by feedback attacks arises from the MU-MIMO channel sounding procedure and the transmission of unprotected feedback information over wireless channels. The present disclosure provides specific technical improvements to the wireless communication protocol through establishing a shared cryptographic key between two network devices, distributing the shared cryptographic key to a wireless device based on the wireless device's capability, and selecting an encryption key at the wireless device based on whether the wireless device supports feedback protection for multi-access point coordination. Through these operations, the present disclosure protects beamforming feedback information from unauthorized interception or modification in coordinated multi-AP environments, using mechanisms designed for multi-AP coordination rather than extending the encryption procedures used in single-AP communications.

The disclosed techniques operate in various embodiments as described herein. By encrypting feedback information using a shared cryptographic key held by both network devices, either network device can decrypt the feedback information from a wireless device associated with the other network device. This approach may reduce the need for each participating access point to establish a separate pairwise key with each wireless device in the coordinated network, which reduces the number of keys that each access point manages and the number of key establishment exchanges required across the coordinated network. The key selection mechanism preserves backward compatibility with wireless devices that do not support feedback protection for multi-access point coordination, because such devices continue to encrypt feedback information using the pairwise key established during association. Because the network devices derive the shared cryptographic key through a separate key agreement procedure instead of sharing an existing pairwise key between them, the pairwise key used within each basic service set remains independent from the shared cryptographic key used for inter-AP coordination.

Although specific embodiments have been described, various combinations of features from different embodiments are contemplated. Features described with respect to one embodiment may be combined with features described with respect to other embodiments. Such combinations are within the scope of the present disclosure.

The embodiments described herein are not limited to any single standard revision, and the scope of the appended claims encompasses implementations that conform to any applicable wireless communication standard that supports the recited operations, including 3GPP Fifth Generation (5G) New Radio (NR) standards employing multi-cell coordination with beamforming feedback.

The methods described herein may be implemented in software executed by one or more processors, in hardware using dedicated logic circuits, or in combinations of software and hardware. Software implementations may include instructions stored in non-transitory computer-readable media including, but not limited to, magnetic storage devices, optical storage devices, solid-state storage devices, or network-accessible storage.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A method for wireless communications, the method comprising:
exchanging, by a first network device with a second network device, security information for establishing a shared cryptographic key;
deriving, by the first network device, the shared cryptographic key based on the exchanged security information;
encrypting, by the first network device, coordination information using the shared cryptographic key, wherein the coordination information is associated with a coordinated wireless operation involving the first network device and the second network device; and
transmitting, by the first network device to the second network device, the encrypted coordination information.

2. The method of claim 1, wherein exchanging the security information comprises exchanging public keys between the first network device and the second network device, and the deriving the shared cryptographic key comprises:
deriving shared secrets based on the exchanged public keys; and
deriving the shared cryptographic key based on the shared secrets.

3. The method of claim 1, wherein exchanging the security information comprises exchanging a plurality of authentication frames between the first network device and the second network device using a multi-AP coordination pre-association security negotiation protocol.

4. The method of claim 1, wherein the encrypted coordination information is transmitted in at least one of a negotiation request frame or a negotiation response frame.

5. The method of claim 1, wherein the coordinated wireless operation comprises at least one of a coordinated beamforming operation or a coordinated spatial reuse operation.

6. The method of claim 1, wherein the shared cryptographic key is different from a pairwise key established between the first network device and a wireless device associated with the first network device.

7. A method for wireless communications, the method comprising:
receiving, by a first wireless device, coordination information from a first network device, the coordination information indicating that the first network device is operating in a coordinated mode with a second network device;
receiving, by the first wireless device from the first network device, a shared cryptographic key, wherein the shared cryptographic key is established between the first network device and the second network device;
encrypting, by the first wireless device, feedback information using the shared cryptographic key, wherein the feedback information comprises channel state information associated with a communication channel between the first wireless device and the first network device; and
transmitting, by the first wireless device, the encrypted feedback information, wherein the encrypted feedback information is decodable by both the first network device and the second network device using the shared cryptographic key.

8. The method of claim 7, further comprising:
transmitting, by the first wireless device, a capability indication indicating support for feedback protection for multi-access point coordination.

9. The method of claim 7, further comprising:
receiving, by the first wireless device from the first network device, a first cryptographic key;
wherein the first cryptographic key is a pairwise key established between the first wireless device and the first network device;
wherein encrypting the feedback information comprises selecting one of the first cryptographic key or the shared cryptographic key based on whether the first wireless device supports feedback protection for multi-access point coordination.

10. The method of claim 7, wherein the feedback information further comprises beamforming feedback angles associated with the communication channel.

11. The method of claim 7, wherein the coordinated mode comprises a coordinated beamforming mode in which the first network device and the second network device perform concurrent transmissions based on the channel state information.

12. The method of claim 7, wherein the encrypted feedback information is transmitted in an action frame.

13. A method for wireless communications, the method comprising:
establishing, by a first network device, a shared cryptographic key with a second network device, wherein the shared cryptographic key is for protecting communications associated with a coordinated operation between the first network device and the second network device;
transmitting, by the first network device to a first wireless device, the shared cryptographic key;
receiving, by the first network device, encrypted feedback information from the first wireless device, wherein the encrypted feedback information is generated by the first wireless device by encrypting feedback information using the shared cryptographic key, and the feedback information comprises channel state information associated with a communication channel between the first wireless device and the first network device; and
decrypting, by the first network device, the encrypted feedback information using the shared cryptographic key.

14. The method of claim 13, wherein establishing the shared cryptographic key comprises:
exchanging public keys between the first network device and the second network device;
deriving shared secrets based on the exchanged public keys; and
deriving the shared cryptographic key
based on the shared secrets.

15. The method of claim 13, wherein establishing the shared cryptographic key comprises exchanging a plurality of authentication frames between the first network device and the second network device using a multi-AP coordination pre-association security negotiation protocol.

16. The method of claim 13, further comprising:
forwarding, by the first network device, the channel state information to the second network device for use in a coordinated beamforming operation.

17. A network device, comprising:
a transceiver;
one or more processors coupled to the transceiver; and
a memory coupled to the one or more processors and storing instructions that, when executed by the one or more processors, cause the network device to:
establish a shared cryptographic key with a second network device for protecting communications associated with a coordinated operation;
transmit, via the transceiver to a first wireless device, the shared cryptographic key;
receive, via the transceiver from the first wireless device, encrypted feedback information, wherein the encrypted feedback information is generated by the first wireless device by encrypting feedback information using the shared cryptographic key, and the feedback information comprises channel state information associated with a communication channel between the first wireless device and the network device; and
decrypt the encrypted feedback information using the shared cryptographic key.

18. The network device of claim 17, wherein the coordinated operation comprises a coordinated beamforming operation in which the network device and the second network device perform concurrent transmissions to respective associated wireless devices.

19. A wireless device, comprising:
a transceiver configured to communicate with a first network device;
one or more processors coupled to the transceiver; and
a memory coupled to the one or more processors and storing instructions that, when executed by the one or more processors, cause the wireless device to:
receive, via the transceiver, coordination information from the first network device, the coordination information indicating that the first network device is operating in a coordinated mode with a second network device;
receive, via the transceiver from the first network device, a shared cryptographic key established between the first network device and the second network device;
encrypt feedback information using the shared cryptographic key, wherein the feedback information comprises channel state information associated with a communication channel between the wireless device and the first network device; and
cause the transceiver to transmit the encrypted feedback information.

20. The wireless device of claim 19, wherein the instructions further cause the wireless device to:
transmit, via the transceiver, a capability indication indicating support for feedback protection for multi-access point coordination.

21. The wireless device of claim 19, wherein the instructions further cause the wireless device to:
receive, via the transceiver from the first network device, a first cryptographic key, the first cryptographic key being a pairwise key established between the wireless device and the first network device; and
select one of the first cryptographic key or the shared cryptographic key for encrypting the feedback information.

22. The wireless device of claim 19, wherein the encrypted feedback information is decodable by both the first network device and the second network device using the shared cryptographic key.
